(19) United States
(12) Patent Application Publication
(10) Pub. No.: US 2011/0060562 A1
(43) Pub. Date: Mar. 10, 2011

(54) Method of determining the elastic modulus of coatings

(76) Inventors: Bekir Sami Yilbas, Dhahran (SA); Iyad Al-Zaharnah, Dhahran (SA)

(21) Appl. No.: 12/585,196

(22) Filed: Sep. 8, 2009

(51) Int. Cl. G06F 17/10

(52) U.S. Cl. 703/2

(57) ABSTRACT

The method of determining the elastic modulus of coatings utilizes numerical modeling and simulation methods to determine physical characteristics of coatings based upon comparisons of measured flexural characteristics with the numerical models and simulations. Particularly, the method of determining the elastic modulus of coatings utilizes a numerical modeling technique, such as the finite element method, to model vibrational frequency and amplitude variation in a substrate material with a metallic or ceramic coating.

### BACKGROUND OF THE INVENTION

1. Field of the Invention

The present invention relates to material testing methods, and particularly to a method of determining the elastic modulus of coatings that uses the measured vibrational frequency and amplitude of a cantilevered test bar to determine the elastic modulus of a coating applied to the bar by application of a numerical model that utilizes the finite element method.

2. Description of the Related Art

Metallic or ceramic coatings find applications in industry for wear, erosion, and corrosion prevention of surfaces from harsh environments. However, mechanical response of the coatings depends on the elastic modulus of the coating. Brittle coating structures with high elastic moduli may cause the early failure of the coating in certain applications. There are many methods available to measure or estimate the elastic modulus of the coating, such as through three-point bending, tensile testing, ultrasonic testing, and a variety of other techniques.

Various tests have been used to characterize the mechanical properties of material samples, particularly of polymer plastics and elastomer or rubbery materials. In one short-term category are impact tests, such as Izod impact, and Durometer testing. A thin piece of material is placed on a hard surface and impacted by a hard object at varying kinetic energies until permanent deformation or rupture is observed. Other hardness tests array materials according to which material will scratch which softer material, for example, diamond scratching sapphire, sapphire scratching quartz, etc. Creep properties are less often determined, since the testing is time-consuming. Samples may be subjected to a constant stress for an extended period at a controlled temperature while strain is measured, resulting in a graph of a time-dependent modulus of elasticity, the “creep modulus,” representing the ratio of stress to strain plotted as a function of time.

Since strain increases over time at constant stress due to material creep, the creep modulus is a decreasing function of time. Families of creep modulus graphs are typically plotted for selected fixed stresses and fixed temperatures. Creep modulus graphs commonly extend from a first measurement at one hour (of sustained stress) to 1000 hours or more. Each graph in a family of creep modulus graphs requires that a separate material sample be maintained at a separate temperature and stress in a test apparatus for the full duration, for example, 1000 hours, indicating the time-consuming and expensive nature of the testing.

For testing of dynamic stress/strain relationships on an intermediate time scale between very short-term impact and very long-term creep, machines are sometimes employed that impose programmable progressively-increasing or cyclically-changing strain over time while measuring stress, typically over a time scale of seconds to minutes. Controlled strain is commonly applied to soft materials, especially elastomers, while stress is measured. On harder materials, where it can be difficult to control strain, stress is varied while strain is measured. In a common testing protocol, stress is increased monotonically while strain is measured. When a specified strain threshold is reached, typically where the material deviates from more or less reversible elastic behavior to plastic strain and permanent deformation, this threshold defines the yield stress. Complete failure or rupture of the sample defines ultimate stress, sometimes called tensile stress. In metals, material samples may be subjected to cyclic stress over millions of cycles at various stress levels, defining a fatigue stress threshold below which samples cease to exhibit progressive weakening or embrittlement leading to failure.

In material testing, variations of elastic properties of materials beyond those described above are often desired, such as the testing of induced vibrational frequency and amplitude of a cantilevered bar. Variations of these elastic properties due to heating are of particular interest. The traditional tests described above, usually not involving programmable test equipment, suffer from several limitations. The longer term tests involving sustained stresses at controlled temperature tie up equipment for long periods of time. Where process control is involved, the value of test data declines rapidly with the time it takes to obtain the data. While impact and scratch hardness types of tests provide quick results, tests for creep properties are far too slow to provide information for tuning real-time process parameters that produce the material.

The short term tests measure only a failure threshold under a fixed set of conditions, providing little insight into other material properties. Combining test results can reveal material properties over wide-ranging conditions, but the results do not generate a predictive, analytical model that could describe material response to a set of conditions outside the specific conditions of the test results. It would be desirable that test results could be used to define a predictive model of material properties, applicable to describing dynamic response of individual cells in a Finite Element Analysis. Families of measured curves obtained under dynamic conditions and at varying temperatures provide a wealth of data that have not been reducible to a predictive model, even when the data span the conditions of concern for actual use of the material. Better modeling, striking a compromise between true and accurate description on the one hand, and generality of application on the other hand, has the potential to lead to better testing, better quality control in manufacture and receiving, and better insight into how the materials behave and might be improved.

Thus, a method of determining the elastic modulus of coatings solving the aforementioned problems is desired.

### SUMMARY OF THE INVENTION

The method of determining the elastic modulus of coatings utilizes numerical modeling and simulation methods to determine physical characteristics of coatings based upon comparisons of measured flexural characteristics with the numerical models and simulations. Particularly, the method of determining the elastic modulus of coatings utilizes a numerical modeling technique, such as the finite element method, to model vibrational frequency and amplitude variation in a substrate material with a metallic or ceramic coating.

The method includes the steps of: (a) establishing a set of variables x, y and z, wherein the variables x, y and z represent Cartesian coordinates of a cantilevered bar having a coating, the cantilevered bar being elongated along the x-axis; (b) calculating a fundamental frequency of vibration of the cantilevered bar such that:

$$z = A cosh [ {( \frac{m {ω}^{2}}{EI} )}^{1 / 4} x ] + B sinh [ {( \frac{m {ω}^{2}}{EI} )}^{1 / 4} x ] + C cos [ {( \frac{m {ω}^{2}}{EI} )}^{1 / 4} x ] + D sin [ {( \frac{m {ω}^{2}}{EI} )}^{1 / 4} x ] ,$$

wherein A, B, C and D are integration constants, m represents a mass of the cantilevered bar, E represents an elastic modulus of the cantilevered bar and the coating, E represents a moment of inertia of the cantilevered bar, and w represents the fundamental frequency of vibration; (c) establishing vibrational boundary conditions for the calculation of the fundamental frequency of vibration; (d) calculating a damped natural frequency of vibration of the heated bar as ω_{d}=ω\sqrt{1−ζ²}, wherein ξ represents a damping constant of the cantilevered bar; (e) calculating a frequency and an amplitude of vibration for the cantilevered bar based upon the damped natural frequency of vibration; (f) measuring an empirical sample frequency and an empirical sample amplitude of at least one sample cantilevered bar having a coating with a known elastic modulus; (g) establishing a numerical model of the frequency and the amplitude of the cantilevered bar having a coating based upon the calculated frequency and calculated amplitude and the empirical sample frequency and the empirical sample amplitude; (h) measuring an empirical test frequency and an empirical test amplitude of a cantilevered bar having a coating to be tested; (i) calculating the elastic modulus of the tested coating based upon the numerical model and the measured empirical test frequency and the measured empirical test amplitude; and (j) displaying results of the calculated elastic modulus.

The step of establishing vibrational boundary conditions preferably includes setting

$$y {\vert}_{x = 0} = 0 and \frac{d y ( x )}{d x} {\vert}_{x = 0} = 0$$

at a fixed end of the bar, and setting

$$\frac{{d}^{2} y ( x )}{d {x}^{2}} {\vert}_{x = l} = 0 and \frac{{d}^{3} y ( x )}{d {x}^{3}} {\vert}_{x = l} = 0$$

at a free end of the bar.

Step (h) preferably comprises applying the coating to a bar, mounting one end of the bar to a cantilever support, applying an impulse force to the opposite end of the bar, and measuring the frequency and amplitude of the resulting vibrations.

These and other features of the present invention will become readily apparent upon further review of the following specification and drawings.

### BRIEF DESCRIPTION OF THE DRAWINGS

FIG. 1 is a diagrammatic view of a system for empirically measuring the vibrational frequency and amplitude of a cantilevered bar having a coating applied thereto in a method of determining the elastic modulus of coatings according to the present invention.

FIG. 2 is a graph showing the amplitude of tip displacement of the free end of the cantilevered bar of FIG. 1 as a function of time for coatings having a different modulus of elasticity.

FIG. 3 is a graph illustrating the time period of an oscillation of the cantilevered bar of FIG. 1 as a function of the elasticity of the coating material.

FIG. 4 is a graph illustrating the maximum amplitude of the oscillating tip of the cantilevered bar of FIG. 1 as a function of the elasticity of the coating material.

FIG. 5 diagrammatically illustrates a computer system for performing the numerical calculation steps of the method of determining the elastic modulus of coatings according to the present invention.

Similar reference characters denote corresponding features consistently throughout the attached drawings.

### DETAILED DESCRIPTION OF THE PREFERRED EMBODIMENTS

The method of determining the elastic modulus of coatings utilizes numerical modeling and simulation methods to determine physical characteristics of coatings based upon comparisons of measured flexural characteristics with the numerical models and simulations. Particularly, the method of determining the elastic modulus of coatings utilizes a numerical modeling technique, such as the finite element method, to model vibrational frequency and amplitude variation in a substrate material with a metallic or ceramic coating.

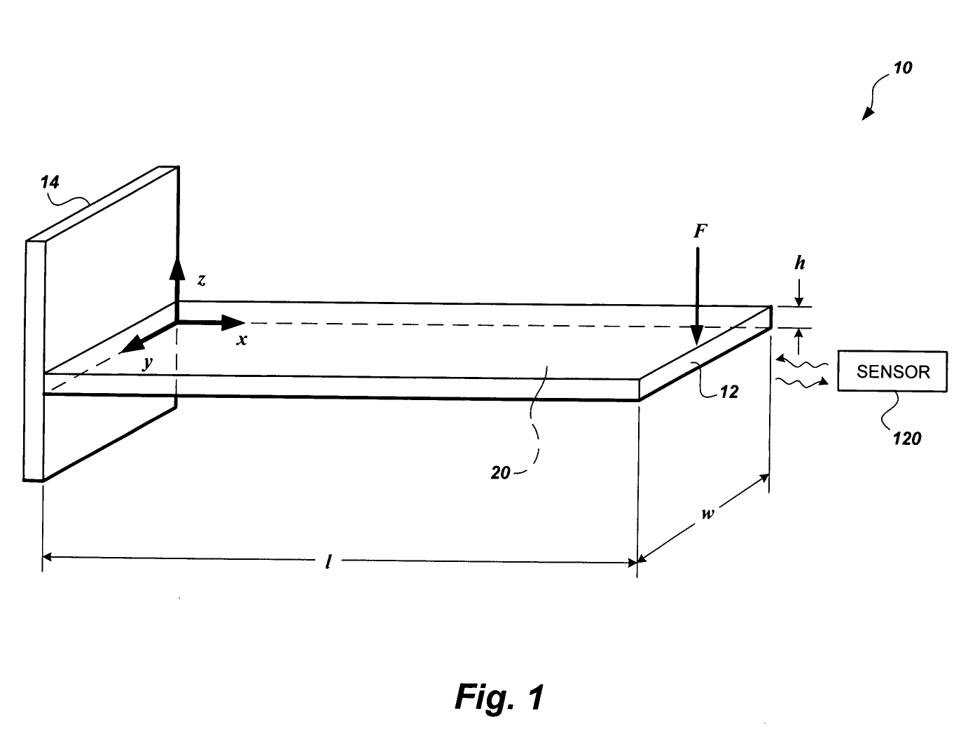

FIG. 1 illustrates the mechanical system for testing both materials having a known modulus of elasticity for developing the numerical model, and for testing materials having an unknown modulus of elasticity. As shown, the system 10 includes a bar or substrate layer 12 supported at one end thereof by a support 14, the bar 12 having a coating applied thereto. Preferably, substrate 12 extends along a substantially horizontal plane, as shown, the cantilever support 14 being oriented along a substantially vertical plane and an impulsive force F being delivered to the substrate 12 at the opposite end thereof, as shown. The bar or substrate 12 is preferably substantially rectangular in cross section, having a width w, a length l, and thickness h oriented in the cantilever arrangement shown in FIG. 1. The method models the effects of flexural characteristics in the substrate when an impulsive load F is applied at the end of the bar 12 opposite support 14. The flexural characteristics of interest are, specifically, the frequency and amplitude of oscillation, which depend, at least in part, upon the elastic modulus of the metallic or ceramic coating formed on the bar. Preferably, the coating is a thin film, having a thickness between approximately 200 and 400 microns.

In FIG. 1, using Cartesian coordinates with the origin of the x, y and z-axes as shown, and with length being measured along the x axis, a length of x=0 corresponds to the location where bar 12 is attached to support 14. In FIG. 1, the upper and lower surfaces are labeled 18 and 20, respectively.

In the method, a numerical model of the flexural characteristics of such a cantilevered and coated bar is developed, based upon measurements of an empirical sample frequency and an empirical sample amplitude of at least one sample cantilevered bar having a coating with a known elastic modulus. As shown in FIG. 1, a sensor 120 is positioned adjacent the free tip of the bar 12. Using an initial sample with known elastic modulus, sensor 120 measures the displacement of the tip of bar 12. Coupled with a timer or timing circuit 122, both amplitude and frequency of the oscillation caused by force F can be measured. Sensor 120 may be an optical sensor or any other suitable type of sensor for measuring displacement of the tip of bar 12. Similarly, timer or timing circuit 122 may be any suitable type of timer or timing program incorporated into processor 114, as is well known in the art of empirical measurements.

In order to develop the numeric model, a simple temperature-independent case is examined. In this case, the differential equation describing the flexural motion of a bar with no heating is given as:

$$\frac{{d}^{4} z}{d {x}^{4}} - ( \frac{{ω}^{2} m}{EI} ) y = 0 \qquad ( 1 )$$

where ω represents the natural frequency values satisfying the solution of equation (1) for certain boundary conditions. E is the modulus of elasticity of the bar material, l is the mass moment of inertia, and m is the mass per unit length of the bar. The general solution of equation (1) is given by equation (2) below:

$$z = A cosh [ {( \frac{m {ω}^{2}}{EI} )}^{1 / 4} x ] + B sinh [ {( \frac{m {ω}^{2}}{EI} )}^{1 / 4} x ] + C cos [ {( \frac{m {ω}^{2}}{EI} )}^{1 / 4} x ] + D sin [ {( \frac{m {ω}^{2}}{EI} )}^{1 / 4} x ]$$

where A, B, C and D are the integration constants and can be found after substitution of the following boundary conditions into equation (2): at the clamped end of the uniform bar

$$( i . e . , x = 0 ) , y {\vert}_{x = 0} = 0 and \frac{d y ( x )}{d x} {\vert}_{x = 0} = 0$$

at a fixed end of the bar, and setting

$$\frac{{d}^{2} y ( x )}{d {x}^{2}} {\vert}_{x = l} = 0 and \frac{{d}^{3} y ( x )}{d {x}^{3}} {\vert}_{x = l} = 0$$

at a free end of the bar, which reduces equation (2) to:

$$cos [ {( \frac{m {ω}^{2}}{EI} )}^{1 / 4} l ] cos [ {( \frac{m {ω}^{2}}{EI} )}^{1 / 4} l ] + 1 = 0 \qquad ( 3 )$$

with the resulting fundamental natural frequency corresponding to the first mode of motion for the cantilevered bar 12 being given by

$${ω}_{fundamental} = {1.875}^{2} \sqrt{\frac{EI}{{ml}^{4}}} .$$

The damped natural frequency is found via ω_{d}=ω_{fundamental}\sqrt{1−ζ²}, where ξ is the damping coefficient of the cantilevered bar 12.

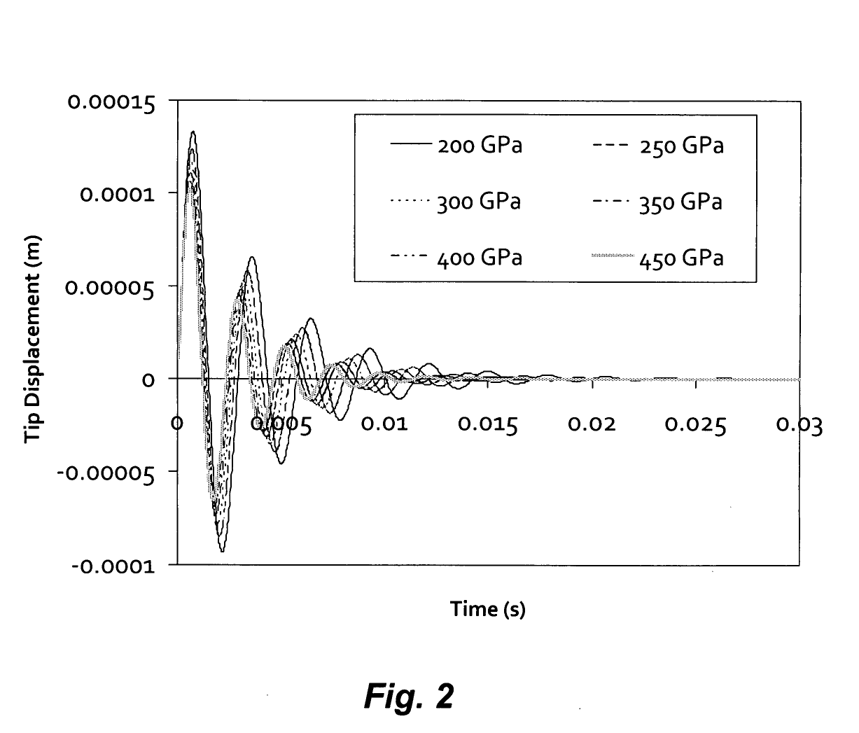

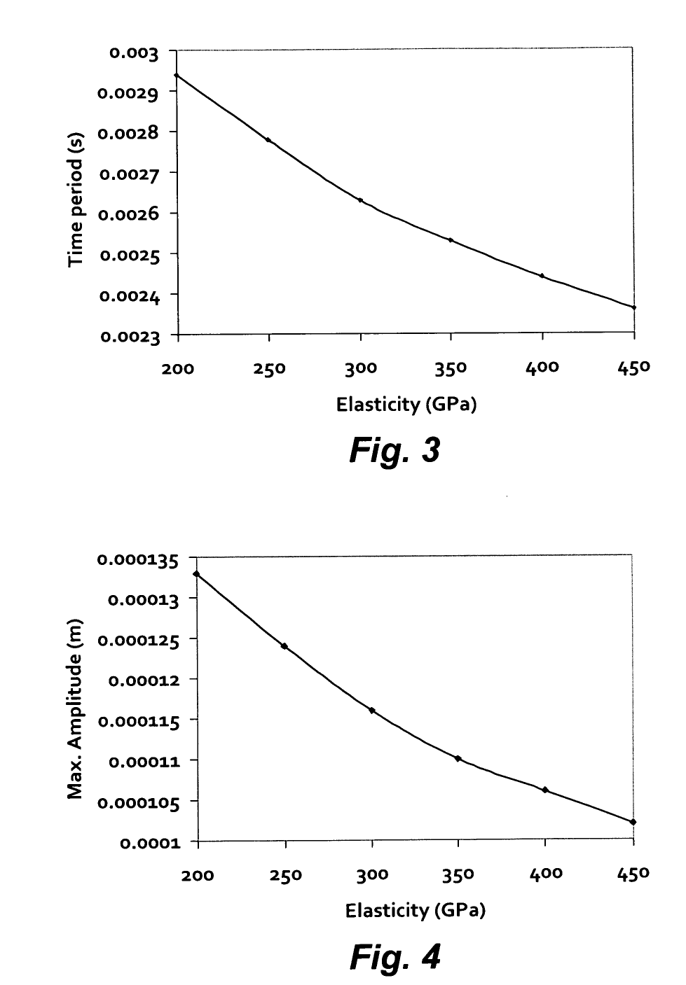

Using the above, an empirical sample frequency and an empirical sample amplitude of at least one sample, and preferably a plurality of samples, of a cantilevered bar having a coating with a known elastic modulus are calculated by measuring the displacement of the tip of the bar with sensor 120. For the bar with known dimensions, mass and elastic modulus, these properties, and the predicted frequency of oscillation using the above flexural equations, allows for the development of a numerical model for frequency of oscillation of the cantilevered bar as a function of elastic modulus. A variety of samples may be provided, with frequency of oscillation being measured for each known material having a known elastic modulus, with the results being stored in a database in memory 112. FIG. 2 illustrates measurement of tip displacement as a function of time for a variety of samples with known elastic moduli, with this data being used to form the numerical model. FIG. 3 illustrates the time period of oscillation of the bar tip as a function of elasticity, generated from the numerical model. FIG. 4 illustrates a calculated maximum amplitude of the bar tip under oscillation as a function of the elasticity of the coating material, calculated from the numerical model.

The numerical modeling is performed using any suitable modeling technique, such as the finite element analysis. In the finite element domain, the uniform bar is divided into SOLID98 ANSYS elements. As is well known in the field of finite element analysis, SOLID98 is a 10-node tetrahedral version of the common 8-node SOLID5 element. The element has a quadratic displacement behavior and is well suited to model irregular meshes (as are typically utilized by CAD/CAM systems). The element is defined by ten nodes with up to six degrees of freedom at each node.

Once the numerical model of the frequency and the amplitude of the cantilevered bar having a coating is established, based upon the calculated frequency and calculated amplitude and the empirical sample frequency and the empirical sample amplitude, the displacement of the tip of a bar 12 having the coating to be tested is measured by sensor 120. From the displacement and time of displacement, the empirical test frequency and empirical test amplitude of the cantilevered bar having the coating to be tested are calculated.

Using the established numerical model with the input empirical test amplitude and empirical test frequency, the elastic modulus of the tested coating can be calculated. The elastic modulus is then displayed to the user via display 118.

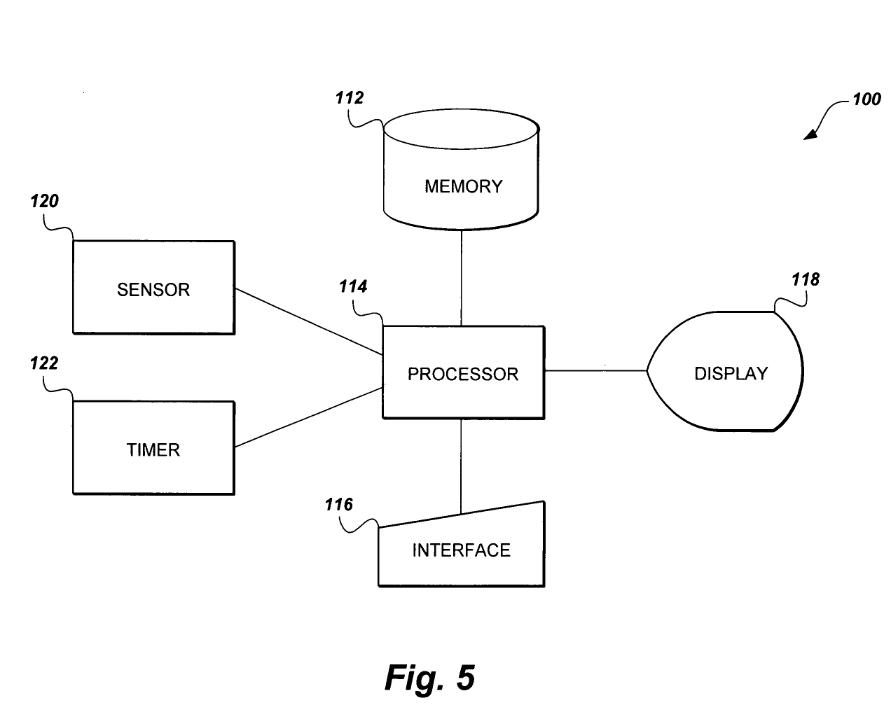

In the above, the calculations may be performed by any suitable computer system, such as that diagrammatically shown in FIG. 5. Data is entered into system 100 via any suitable type of user interface 116, and may be stored in memory 112, which may be any suitable type of computer readable and programmable memory. Calculations are performed by processor 114, which may be any suitable type of computer processor and may be displayed to the user on display 118, which may be any suitable type of computer display.

Processor 114 may be associated with, or incorporated into, any suitable type of computing device, for example, a personal computer or a programmable logic controller. The display 118, the processor 114, the memory 112 and any associated computer readable recording media and/or communication transmission media are in communication with one another by any suitable type of data bus, as is well known in the art.

Examples of computer-readable recording media include a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

It is to be understood that the present invention is not limited to the embodiments described above, but encompasses any and all embodiments within the scope of the following claims.

We claim:

1. A method of determining the elastic modulus of coatings, comprising the steps of:
establishing a set of variables x, y, and z, wherein the variables x, y and z represent Cartesian coordinates of a cantilevered bar having a coating, the cantilevered bar being elongated along the x-axis;
calculating a fundamental frequency of vibration of the cantilevered bar such that:
$$z = A cosh [ {( \frac{m {ω}^{2}}{EI} )}^{1 / 4} x ] + B sinh [ {( \frac{m {ω}^{2}}{EI} )}^{1 / 4} x ] + C cos [ {( \frac{m {ω}^{2}}{EI} )}^{1 / 4} x ] + D sin [ {( \frac{m {ω}^{2}}{EI} )}^{1 / 4} x ] ,$$
wherein A, B, C and D are integration constants, m represents a mass of the cantilevered bar, E represents an elastic modulus of the cantilevered bar and the coating, I represents a moment of inertia of the cantilevered bar, and
ω represents the fundamental frequency of vibration;
establishing vibrational boundary conditions for the calculation of the fundamental frequency of vibration;
calculating a damped natural frequency of vibration of the heated bar as ω_{d}=ω\sqrt{1−ζ²}, wherein ξ represents a damping constant of the cantilevered bar;
calculating a frequency and an amplitude of vibration for the cantilevered bar based upon the damped natural frequency of vibration;
measuring an empirical sample frequency and an empirical sample amplitude of at least one sample cantilevered bar having a coating with a known elastic modulus; establishing a numerical model of the frequency and the amplitude of the cantilevered bar having a coating based upon the calculated frequency and calculated amplitude and the empirical sample frequency and the empirical sample amplitude;
measuring an empirical test frequency and an empirical test amplitude of a cantilevered bar having a coating to be tested;
calculating the elastic modulus of the tested coating based upon the numerical model and the measured empirical test frequency and the measured empirical test amplitude; and
displaying results of the calculated elastic modulus.

2. The method of determining the elastic modulus of coatings as recited in claim 1, wherein the step of establishing vibrational boundary conditions includes setting
$$y {\vert}_{x = 0} = 0 and \frac{d y ( x )}{d x} {\vert}_{x = 0} = 0$$
at a fixed end of the bar, and setting
$$\frac{{d}^{2} y ( x )}{d {x}^{2}} {\vert}_{x = l} = 0 and \frac{{d}^{3} y ( x )}{d {x}^{3}} {\vert}_{x = l} = 0$$
at a free end of the cantilevered bar.

3. The method of determining the elastic modulus of coatings as recited in claim 2, wherein the numerical model of the frequency and the amplitude of the cantilevered bar is developed using the finite element method.

4. The method of determining the elastic modulus of coatings as recited in claim 3, wherein the cantilevered bar is numerically divided into a plurality of SOLID98 ANSYS elements.

5. The method of determining the elastic modulus of coatings as recited in claim 3, wherein the step of measuring an empirical test frequency and an empirical test amplitude of a cantilevered bar having a coating to be tested comprises the steps of:
applying the coating to the bar;
mounting one end of the bar to a cantilever support;
applying an impulse force to the opposite end of the bar; and
measuring the frequency and amplitude of the resulting vibrations.

6. A system for determining the elastic modulus of coatings, comprising:
a processor;
computer readable memory coupled to the processor;
a user interface coupled to the processor;
a display coupled to the processor;
means for measuring displacement of a tip of a cantilevered bar having a coating, said means being coupled to the processor;
software stored in the memory and executable by the processor, the software having:
means for a set of variables x, y, and z, wherein the variables x, y and z represent Cartesian coordinates of a cantilevered bar having a coating, the cantilevered bar being elongated along the x-axis;
means for calculating a fundamental frequency of vibration of the cantilevered bar such that:
$$z = A cosh [ {( \frac{m {ω}^{2}}{EI} )}^{1 / 4} x ] + B sinh [ {( \frac{m {ω}^{2}}{EI} )}^{1 / 4} x ] + C cos [ {( \frac{m {ω}^{2}}{EI} )}^{1 / 4} x ] + D sin [ {( \frac{m {ω}^{2}}{EI} )}^{1 / 4} x ] ,$$
wherein A, B, C and D are integration constants, m represents a mass of the cantilevered bar, E represents an elastic modulus of the cantilevered bar and the coating, I represents a moment of inertia of the cantilevered bar, and w represents the fundamental frequency of vibration;
means for establishing vibrational boundary conditions for the calculation of the fundamental frequency of vibration;
means for calculating a damped natural frequency of vibration of the heated bar as ω_{d}=ω\sqrt{1−ζ²}, wherein ξ represents a damping constant of the cantilevered bar;
means for calculating a frequency and an amplitude of vibration for the cantilevered bar based upon the damped natural frequency of vibration;
means for measuring an empirical sample frequency and an empirical sample amplitude of at least one sample cantilevered bar having a coating with a known elastic modulus;
means for establishing a numerical model of the frequency and the amplitude of the cantilevered bar having a coating based upon the calculated frequency and calculated amplitude and the empirical sample frequency and the empirical sample amplitude;
means for measuring an empirical test frequency and an empirical test amplitude of a cantilevered bar having a coating to be tested;
means for calculating the elastic modulus of the tested coating based upon the numerical model and the measured empirical test frequency and the measured empirical test amplitude; and
means for displaying results of the calculated elastic modulus.

7. A computer software product that includes a medium readable by a processor, the medium having stored thereon a set of instructions for determining the elastic modulus of coatings, the instructions comprising:
(a) a first sequence of instructions which, when executed by the processor, causes the processor to establish a set of variables x, y, and z, wherein the variables x, y and z represent Cartesian coordinates of a cantilevered bar having a coating, the cantilevered bar being elongated along the x-axis;
(b) a second sequence of instructions which, when executed by the processor, causes the processor to calculate a fundamental frequency of vibration of the cantilevered bar such that
$$z = A cosh [ {( \frac{m {ω}^{2}}{EI} )}^{1 / 4} x ] + B sinh [ {( \frac{m {ω}^{2}}{EI} )}^{1 / 4} x ] + C cos [ {( \frac{m {ω}^{2}}{EI} )}^{1 / 4} x ] + D sin [ {( \frac{m {ω}^{2}}{EI} )}^{1 / 4} x ] ,$$
wherein A, B, C and D are integration constants, m represents a mass of the cantilevered bar, E represents an elastic modulus of the cantilevered bar and the coating, I represents a moment of inertia of the cantilevered bar, and ω represents the fundamental frequency of vibration;
(c) a third sequence of instructions which, when executed by the processor, causes the processor to establish vibrational boundary conditions for the calculation of the fundamental frequency of vibration;
(d) a fourth sequence of instructions which, when executed by the processor, causes the processor to calculate a damped natural frequency of vibration of the heated bar as ω_{d}=ω\sqrt{1−ζ²}, wherein ξ represents a damping constant of the cantilevered bar;
(e) a fifth sequence of instructions which, when executed by the processor, causes the processor to calculate a frequency and an amplitude of vibration for the cantilevered bar based upon the damped natural frequency of vibration;
(f) a sixth sequence of instructions which, when executed by the processor, causes the processor to establish a numerical model of the frequency and the amplitude of the cantilevered bar having a coating based upon the calculated frequency and calculated amplitude and a measured empirical sample frequency and a measured empirical sample amplitude;
(g) a seventh sequence of instructions which, when executed by the processor, causes the processor to calculate the elastic modulus of a tested coating based upon the numerical model and a measured empirical test frequency and a measured empirical test amplitude; and
(h) an eighth sequence of instructions which, when executed by the processor, causes the processor to display results of the calculated elastic modulus.
